(19) United States
(12) Patent Application Publication
(10) Pub. No.: US 2008/0085090 A1
(43) Pub. Date: Apr. 10, 2008

(54) Crimp and crimp mechanism for fiber optic connector

(76) Inventors: David W. Meek, Ft. Worth, TX (US); Jeffrey D. Palmer, Ft. Worth, TX (US); Joshua D. Raker, Lewisville, TX (US); Kristine A. McEvoy, Irving, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/545,284

(22) Filed: Oct. 10, 2006

(51) Int. Cl. G02B 6/00

(52) U.S. Cl. 385/134

(57) ABSTRACT

An improved mechanical crimp provides increased fiber retention, while reducing the force required to form the crimp so that the crimp can be formed using a compact crimp mechanism disposed on a handheld installation tool. The crimp includes a deformable crimp tube and an optical fiber disposed within the crimp tube. A radial cross section of the crimp defines a plurality of alternating concave and convex outer surfaces. The crimp mechanism includes a base plate and a pair of crimp arms movably mounted on the base plate such that the crimp arms define a crimp area. The crimp mechanism further comprises an eccentric engaging at least one of the crimp arms and movably mounted on the base plate between a first position wherein the crimp arms are spaced apart at the crimp area and a second position wherein the crimp arms are not spaced apart at the crimp area.

### BACKGROUND OF THE INVENTION

1. Field of the Invention

The present invention relates generally to a crimp for a fiber optic connector and a crimp mechanism for forming the crimp. More specifically, the invention is an improved mechanical crimp that provides increased fiber retention, while reducing the force required to complete the crimp so that the crimp can be formed using a crimp mechanism disposed on a handheld installation tool.

2. Description of the Related Art

Although fiber optic connectors can generally be most efficiently and reliably mounted upon the end portion of an optical fiber in a factory setting during the production of fiber optic cable, many fiber optic connectors must be mounted upon the end portion of an optical fiber in the field. As such, a number of fiber optic connectors have been developed to facilitate installation of a field optical fiber onto the connector. One advantageous type of fiber optic connector that is specifically designed to facilitate field installation is the UniCam® family of mechanical splice connectors available from Corning Cable Systems of Hickory, N.C. Once the splice has been activated, the field optical fiber typically is strain-relieved to the fiber optic connector to complete the termination process. Strain relief may be accomplished in a variety of ways, including for example, deforming a metal crimp tube around the field optical fiber adjacent the rear of the connector. The deformed crimp tube provides increased retention of the field optical fiber on the connector. The crimp process may be accomplished using a separate crimp mechanism, or may be accomplished using a crimp mechanism that is disposed on an installation tool for terminating the field optical fiber to the connector. Regardless, mechanical crimps historically have been formed with various geometries, including, a two-sided flat crimp and a multi-sided flat crimp.

An example of a known crimp mechanism 10 for forming a two-sided flat crimp is shown in FIG. 1A and a radial cross-section of the resulting crimp is illustrated in FIG. 1B. The crimp shown in FIG. 1B is commonly referred to as a “flat crimp” since the crimp tube 40 is deformed into opposing sides 42, 44 defining a generally flat contour. The crimp mechanism 10 is a pliers-type device that forms the crimp around the field optical fiber 50 once the splice is activated and the fiber optic connector is removed from an installation tool, thereby strain-relieving the field optical fiber to the connector. The deformable crimp tube 40 adjacent the rear of the connector is positioned between the crimp arms 12, 14, and the handles 13, 15 are then squeezed together to close the crimp arms around the crimp tube and the field optical fiber 50. A two-sided flat crimp may also be disposed on an installation tool (not shown) by replacing one of the crimp arms with a stationary anvil. The moveable crimp arm is positioned over the crimp tube and activated (e.g., depressed, rotated, etc.) to form the crimp. In either instance, use of the crimp mechanism 10 results in the crimp tube 40 deforming between the crimp arms (or between the moveable crimp arm and the stationary anvil) 13, 15, and impinging upon the buffer 55 of the field optical fiber 50. As used herein, the term “buffer” or “buffer portion” refers to the jacket, sheath, coating or other protective outer component of the field optical fiber 50. The field optical fiber 50 may be positioned loosely within the buffer 55, but typically the buffer is applied directly onto the field optical fiber (i.e., tight-buffered). Regardless, the crimp tube 40 impinging on the buffer 55 provides mechanical strain relief to the field optical fiber 50 terminated on the fiber optic connector.

An example of a known crimp mechanism 20 for forming a multi-sided flat crimp is shown in FIG. 2A and a radial cross-section of the resulting crimp is illustrated in FIG. 2B. The crimp shown in FIG. 2B is commonly referred to as a “diamond crimp” since the crimp tube is deformed into pairs of opposing sides 41, 43 and 42, 44 defining a generally diamond-shaped contour. The crimp mechanism 20 is also a pliers-type mechanism that is utilized to form the crimp around the field optical fiber 50 once the splice is activated and the fiber optic connector is removed from an installation tool, thereby strain-relieving the field optical fiber to the connector. The deformable crimp tube 40 adjacent the rear of the connector is positioned between the crimp arms 22, 24, and the handles 23, 25 are then squeezed together to close the crimp arms around the crimp tube and the field optical fiber 50. A multi-sided flat crimp may also be disposed on an installation tool (not shown) by replacing one of the crimp arms with a stationary anvil. The moveable crimp arm is positioned over the crimp tube and activated (e.g., depressed, rotated, etc.) to form the crimp. In either instance, use of the crimp mechanism results in the crimp tube 40 deforming between the crimp arms (or between the moveable crimp arm and the stationary anvil) 22, 24, and impinging upon the buffer 55 of the field optical fiber 50, as previously described. Regardless, the crimp tube 40 impinging on the buffer 55 provides mechanical strain relief to the field optical fiber 50 terminated on the fiber optic connector.

Due to bandwidth and transmission speed advantages, there is a desire to increase optical fiber penetration into more demanding communications markets, such as fiber to the business and fiber to the home, to create all fiber optical networks, generically referred to as “FTTx networks.” The above-described flat crimps, however, have the known disadvantage that a significant crimp force is required to overcome the inherent hoop stress of the metal crimp tube and thereby deform the generally circular cross section of the crimp tube into the desired geometry of the crimp. The crimp force required is due primarily to the increasing contact area between the crimp tube and the flat surfaces of the crimp mechanism as the crimp is formed and the metal of the deformable crimp tube flows along the crimp mechanism. The crimp force necessary to overcome the hoop stress of the crimp tube and form a flat crimp has been achieved in the past by utilizing cantilevered crimp arms, such as the pliers-type crimp mechanisms described above and shown in FIG. 1A and FIG. 2A. The use of cantilevered crimp arms to generate greater mechanical advantage, however, causes the crimp mechanism to be larger than is practical for a handheld installation tool. A handheld installation tool is desirable for field installation of a fiber optic connector, particularly in a dense FTTx network requiring a large number of optical connections. The geometry of the crimp is also known to introduce attenuation into an optical network due to the micro-bending induced in the field optical fiber as the crimp mechanism forms the crimp. Given the increased number of optical connections in an FTTx network, careful consideration must be given to the geometry of the crimp to avoid, or to at least minimize, attenuation introduced into the optical system as a result of the crimp.

Based on the foregoing, it is apparent that an improved mechanical crimp is needed that provides increased fiber retention, while reducing the force required to form the crimp so that the crimp can be formed using a crimp mechanism disposed on a handheld installation tool. A crimp mechanism for forming the crimp is also needed that provides sufficient mechanical advantage to overcome the inherent hoop stress of a deformable crimp tube, even when the crimp mechanism is disposed on a handheld installation tool. In addition, a crimp and crimp mechanism are needed that eliminate, or at least minimize, attenuation introduced into an optical system as a result of the crimp.

### BRIEF SUMMARY OF THE INVENTION

To achieve the foregoing and other objects, and in accordance with the purposes of the invention as broadly described herein, the present invention provides various embodiments of a crimp and a crimp mechanism for forming the crimp. In the various embodiments, the improved mechanical crimp provides increased fiber retention for retaining an optical fiber on a fiber optic connector, while reducing the force required to form the crimp so that the crimp can be formed using a crimp mechanism disposed on a handheld installation tool. The crimp mechanism provides sufficient mechanical advantage to overcome the inherent hoop stress of a deformable crimp tube, even when the crimp mechanism is disposed on a handheld installation tool. At the same time, the crimp and the crimp mechanism eliminate, or at least minimize, attenuation of an optical fiber terminated on a fiber optic connector.

In one aspect, the invention embodies a crimp for retaining an optical fiber on a fiber optic connector. The crimp comprises a deformable crimp tube and an optical fiber disposed within the crimp tube. The optical fiber comprises an optical waveguide for transmitting optical signals and a buffer extending radially outwardly of the optical waveguide. The crimp tube is deformed by a crimp mechanism to impinge upon the buffer such that a radial cross section of the deformed crimp tube defines a plurality of alternating concave and convex outer surfaces. In one embodiment, the plurality of alternating concave and convex outer surfaces comprises a first pair of opposing concave outer surfaces and a second pair of opposing concave outer surfaces. Preferably, the first pair of concave outer surfaces and the second pair of concave outer surfaces are separated by convex outer surfaces such that the plurality of alternating concave and convex outer surfaces form a continuous clover shape.

In another aspect, the invention embodies a crimp for retaining an optical fiber on a fiber optic connector wherein the crimp comprises an optical fiber including an optical waveguide for transmitting optical signals and a buffer extending radially outwardly of the optical waveguide. The crimp further comprises a deformable crimp tube disposed about the optical fiber. The crimp tube has a radial cross section that is generally circular in an un-deformed configuration and that comprises more than four points of inflection in a deformed configuration. In one embodiment, the points of inflection define a plurality of alternating concave and convex outer surfaces comprising a first pair of opposing concave outer surfaces and a second pair of opposing concave outer surfaces separated by convex outer surfaces. Preferably, the radial cross section of the crimp tube forms a continuous clover shape in the deformed configuration.

In yet another aspect, the invention embodies a crimp mechanism for forming a crimp to retain an optical fiber on a fiber optic connector. The crimp mechanism comprises a base plate and a pair of crimp arms movably mounted on the base plate such that the crimp arms define a crimp area for forming the crimp. The crimp mechanism further comprises an eccentric movably mounted on the base plate and adapted to engage at least one of the crimp arms. The eccentric being movable between a first position wherein the crimp arms are spaced apart at the crimp area and a second position wherein the crimp arms are not spaced apart at the crimp area. In one embodiment, the crimp arms are pivotally mounted to the base plate about a first shaft and the eccentric is pivotally mounted to the base plate about a second shaft. Preferably, the eccentric is disposed between the crimp arms and the eccentric is rotated relative to the base plate and the crimp arms between the first position and the second position to form the crimp. The crimp mechanism may further comprise an elastic element for biasing the crimp arms apart at the crimp area.

In yet another aspect, the invention embodies a crimp mechanism comprising a pair of crimp arms. At least one crimp arm is movable relative to the other crimp arm between an opened position for receiving a crimp element and a closed position for forming a crimp on the crimp element. The crimp mechanism further comprises an actuator operable to engage the at least one crimp arm and configured to rotate relative to the crimp arms between the opened position and the closed position. In one embodiment, the actuator comprises an eccentric and the at least one crimp arm comprises a cam surface that is engaged by the eccentric to move the at least one crimp arm between the opened position and the closed position. In another embodiment, the crimp arms are pivotally mounted on a first shaft and the eccentric is pivotally mounted on a second shaft disposed between the crimp arms. The crimp arms define a crimp area and the first shaft is positioned medially between the crimp area and the second shaft. Preferably, the first shaft is generally perpendicular to a plane defined by the crimp arms and the second shaft is generally parallel to the first shaft.

In yet another aspect, the invention embodies a crimp mechanism for forming a crimp on a deformable crimp tube to retain an optical fiber disposed within the crimp tube on a fiber optic connector. The crimp mechanism comprises a base plate defining a first plane and a pair of crimp arms disposed in a second plane generally parallel to the first plane. The crimp arms define a crimp area and at least one crimp arm is movable relative to the other crimp arm about a first pivot secured to the base plate that is generally perpendicular to the second plane. The crimp mechanism further comprises an actuator movably mounted on a second pivot secured to the base plate that is generally parallel to the first pivot. The actuator engages the at least one crimp arm to move the at least one crimp arm about the first pivot between an opened position for receiving the crimp tube and a closed position for forming the crimp on the crimp tube and the optical fiber.

In yet another aspect, the invention embodies a method of forming a crimp in a deformable crimp tube to retain an optical fiber disposed within the crimp tube on a fiber optic connector. The method comprises terminating the optical fiber on the fiber optic connector. Once the optical fiber is terminated on the connector, an actuator is rotated from a first position to a second position to move at least one of a pair of crimp arms of a crimp mechanism so that the crimp arms close together to form the crimp on the crimp tube and the optical fiber. The actuator is then rotated from the second position to the first position so that the crimp arms move apart to release the crimp tube and the optical fiber from the crimp mechanism.

### BRIEF DESCRIPTION OF THE DRAWINGS

These and other features, aspects and advantages of the present invention are better understood when the following detailed description of the invention is read with reference to the accompanying drawings, in which:

FIG. 1A is a perspective view of a known crimp mechanism for forming a two-sided flat crimp on a deformable crimp tube around an optical fiber disposed within the crimp tube.

FIG. 1B is a radial cross section of the crimp that results from use of the crimp mechanism of FIG. 1A to form the two-sided flat crimp.

FIG. 2A is a perspective view of a known crimp mechanism for forming a multi-sided flat crimp on a deformable crimp tube around an optical fiber disposed within the crimp tube.

FIG. 2B is a radial cross section of the crimp that results from use of the crimp mechanism of FIG. 2A to form the multi-sided flat crimp.

FIG. 3 is a radial cross section of the crimp that results from use of a crimp mechanism according to the present invention to form a crimp on a deformable crimp tube around an optical fiber disposed within the crimp tube.

FIG. 4A is a perspective view of a crimp mechanism according to the present invention shown in an opened position.

FIG. 4B is a perspective view of the crimp mechanism of FIG. 4A shown in a closed position.

FIG. 4C is an enlarged detail view of the crimp area of the crimp mechanism shown in FIG. 4B.

FIG. 5A is a perspective view of another crimp mechanism according to the present invention for forming a crimp according to the present invention on a crimp tube around an optical fiber of a fiber optic connector with the crimp mechanism shown in an opened position.

FIG. 5B is a perspective view of the crimp mechanism of FIG. 5A for forming a crimp on a crimp tube around an optical fiber of a fiber optic connector with the crimp mechanism shown in a closed position.

FIG. 6A is an end perspective view showing the crimp mechanism of FIG. SA disposed on a handheld installation tool for terminating a field optical fiber on a field installable fiber optic connector.

FIG. 6B is a top plan view of the crimp mechanism and the handheld installation tool of FIG. 6A.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings.

The various embodiments shown and described herein provide a crimp and a crimp mechanism for forming the crimp. The improved mechanical crimp provides increased fiber retention for retaining an optical fiber on a fiber optic connector, while reducing the force required to complete the crimp so that the crimp can be formed using a crimp mechanism disposed on a handheld installation tool. In particular, the geometry of the crimp is optimized to minimize the activation force required to complete the crimp. As a result, the crimp mechanism provides sufficient mechanical advantage to form the crimp, while remaining small enough to be packaged within a handheld installation tool for a field-installable fiber optic connector. In addition, the geometry of the crimp and the activation force imparted by the crimp mechanism eliminate, or at least minimize, attenuation of the optical fiber.

A radial cross section of a crimp according to the present invention for retaining an optical fiber on a fiber optic connector is shown in FIG. 3. The crimp comprises a deformable crimp tube 40 and an optical fiber 50 disposed within the crimp tube. The crimp tube 40 may be made of any deformable material suitable for use with the crimp mechanisms shown and described herein. Typically, however, the crimp tube 40 is made of a malleable metal, such as copper or bronze. The optical fiber 50 is intended to include all types of single mode and multi-mode light waveguides, including one or more bare optical fibers, coated optical fibers, loose-tube optical fibers, tight-buffered optical fibers, ribbon optical fibers or any other expedient for transmitting light signals that is configured to be retained on a fiber optic connector by a mechanical crimp. As shown herein, the optical fiber 50 comprises a central optical waveguide 52, surrounded by a conventional cladding 54, which in turn is surrounded by a conventional buffer 55. Typically, the optical waveguide 52 is made of a glass or other light conductive material and has an outer diameter of about 125-127 microns. The cladding 54 is typically made of an opaque plastic material coated onto the optical waveguide 52 and has an outer diameter of about 250-520 microns. The buffer 55 is similarly made of an opaque plastic material extruded onto the cladding 54 and has an outer diameter of at least about 900 microns. As shown, the buffer 55 is applied directly onto the cladding 54 and optical waveguide 52, commonly referred to in the art as “tight-buffered.” However, the optical fiber 50 may have different constructions and configurations (e.g., loose-tube) without departing from the intended scope of the present invention. Regardless, buffer 55 is the jacket, sheath, coating or other protective outer component of the field optical fiber 50 that is used for strain-relieving the optical fiber to a fiber optic connector in the manner shown and described herein, commonly referred to in the art as “crimping.”

In the exemplary embodiments shown and described herein, the crimp tube 40 is deformed by a crimp mechanism (as will be described) to impinge upon the buffer 55 of the optical fiber 50 such that the radial cross section of the deformed crimp tube and optical fiber shown in FIG. 3 defines a plurality of alternating concave and convex outer surfaces. As shown, the plurality of alternating concave and convex outer surfaces comprises a first pair of opposing concave outer surfaces 41, 43, and a second pair of opposing concave outer surfaces 42, 44. The first pair of concave outer surfaces 41, 43 and the second pair of concave outer surfaces 42, 44 are separated by convex outer surfaces 46, 47, 48, 49. As a result, the plurality of alternating concave and convex outer surfaces forms a continuous clover shape. Considering the geometry of the crimp from a different perspective, the crimp tube 40 has a radial cross section that is generally circular in an un-deformed configuration and that comprises more than four points of inflection in the deformed configuration shown in FIG. 3. The points of inflection define the plurality of alternating concave outer surfaces 41, 42, 43, 44 and convex outer surfaces 46, 47, 48, 49. More particularly, the points of inflection define the first pair of opposing concave outer surfaces 41, 43, and the second pair of opposing concave outer surfaces 42, 44 separated by the convex outer surfaces 46, 47, 48, 49, respectively. As a result, the radial cross section of the crimp tube 40 forms a continuous clover shape in the deformed configuration.

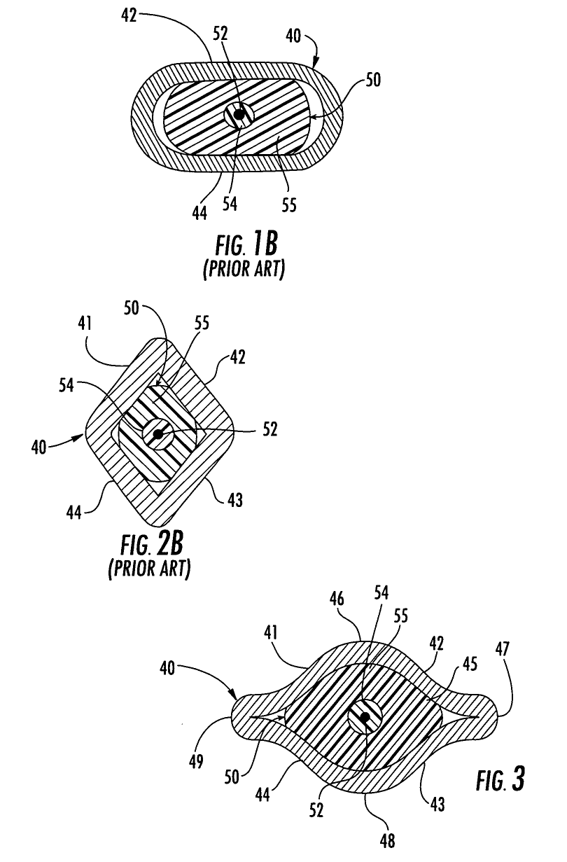

Various tests have been performed to confirm that the “clover” crimp provides increased fiber retention, while reducing the force required to complete the crimp, and either eliminates or minimizes attenuation resulting from the crimp. Tensile load testing was conducted to compare the pull-out force of an optical fiber (i.e., the fiber retention) disposed within a crimp tube having a “diamond” crimp, as shown in FIG. 2B, and an optical fiber disposed within a crimp tube having a “clover” crimp, as shown in FIG. 3. A pliers-type crimp mechanism was used to apply both crimps with an increasing amount of force (i.e., activation force) being applied to the cantilevered crimp arms of the crimp mechanism. The pull-out forces (lbs.) measured can be summarized as follows.

| Activation Force | Diamond Crimp | Clover Crimp |
|---|---|---|
| 10 | (no crimp) | 1.33 |
| 12.5 | (no crimp) | 1.87 |
| 15 | 0.35 | 2.16 |
| 17.5 | 1.02 | 2.31 |
| 20 | 1.15 | 2.39 |
| Full | 2.28 | 2.53 |

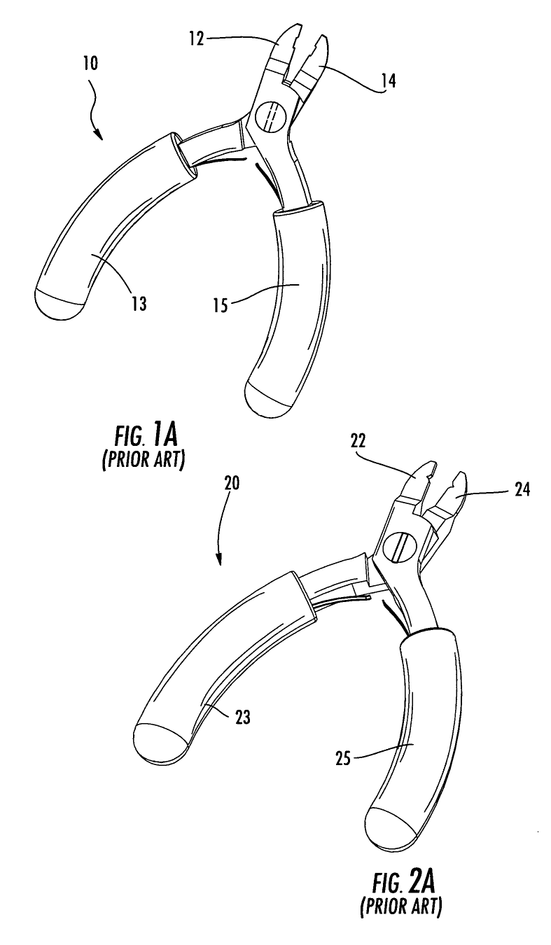

The difference in signal loss before and after crimping a single mode optical fiber and a multi-mode optical fiber (i.e., attenuation resulting from the crimp) was also measured. The attenuation of single mode optical fibers was determined at wavelengths of 1310 and 1550 nanometers, while the attenuation of multi-mode optical fibers was determined at wavelengths of 850 and 1310 nanometers. The average attenuation resulting from a “flat” crimp, as shown in FIG. 1B, a “diamond” crimp and a “clover” crimp were compared. The pull-out force after crimping was also determined by tensile load testing. The attenuation (db) and the pull-out force (lbs.) measured for single mode and multi-mode optical fibers at the different wavelengths can be summarized as follows.

| Mode/Wavelength | Flat Crimp | Diamond Crimp | Clover Crimp |
|---|---|---|---|
| SM/1310 nm | .024 | .012 | .006 |
| SM/1550 nm | .036 | .014 | .006 |
| SM Pull-out Force | 1.47 | 1.88 | 2.52 |
| MM/850 nm | .034 | .040 | .028 |
| MM/1310 nm | .022 | .040 | .022 |
| MM Pull-out Force | 1.50 | 2.26 | 2.64 |

Based on the test results, it is apparent that the geometry of the clover crimp, as shown in FIG. 3, provides increased fiber retention for an optical fiber mechanically strain-relieved on a fiber optic connector, while reducing the force required to complete the crimp. At the same time, the geometry of the crimp eliminates, or at least minimizes, the attenuation introduced into an optical system as a result of the crimp.

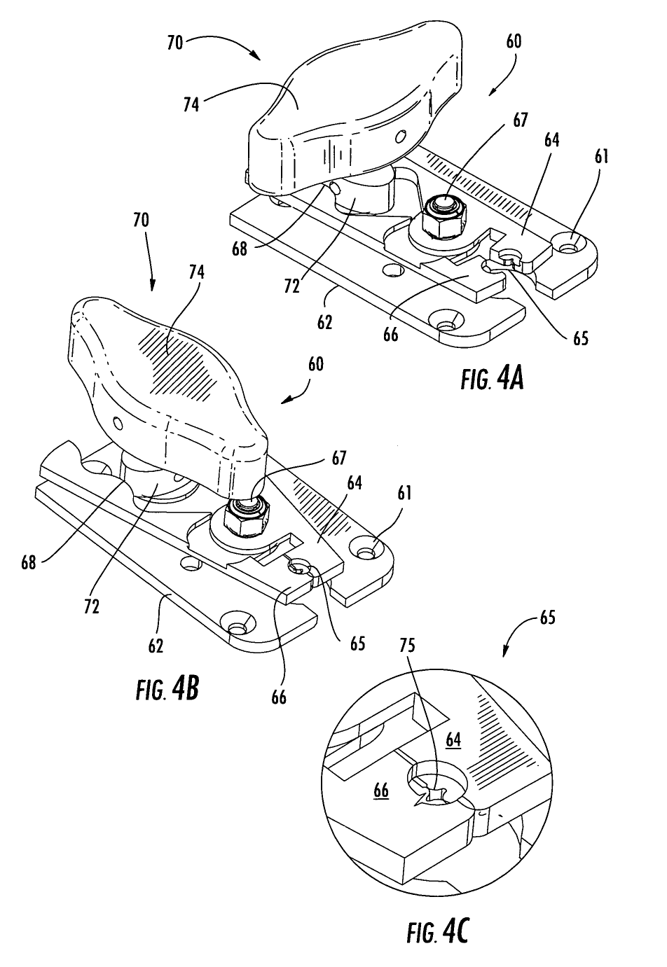

A crimp mechanism 60 according to the invention suitable for forming a crimp around a deformable crimp tube 40 and an optical fiber 50 disposed within the crimp tube is shown in an opened position in FIG. 4A. The crimp mechanism 60 comprises a generally planar base plate 62 that defines a first plane and a pair of crimp arms 64, 66 that are disposed in a second plane generally parallel to the first plane defined by the base plate. The crimp arms 64, 66 are movably mounted to the base plate 62. At least one of the crimp arms 64, 66 is movable relative to the base plate 62 and relative to the other crimp arm. Preferably, however, both crimp arms 64, 66 are movable relative to the base plate 62 and relative to one another, as shown and described herein. The crimp arms 64, 66 define a crimp area 65 adjacent one end of the base plate 62 for receiving the crimp tube 40 and optical fiber 50, and for forming the crimp. The crimp tube 40 and optical fiber 50 are received between the crimp arms 64, 66 within the crimp area 65 with the crimp mechanism 60 in the opened position, and the crimp is formed as the crimp arms close together in the closed position shown in FIG. 4B. An enlarged detail of the crimp area 65 with the crimp mechanism 60 in the closed position (FIG. 4B) is shown in FIG. 4C.

As shown herein, the crimp arms 64, 66 are pivotally mounted on the base plate 62 by a first shaft 67 having a smooth outer surface. The first shaft (or pivot) 67 is secured to the base plate 62 adjacent one end and is configured to receive a fastener adjacent the other end to retain the crimp arms 64, 66 on the crimp mechanism 60. In the exemplary embodiments illustrated herein, the first shaft 67 has an externally threaded portion at the other end that receives a conventional internally threaded nut. The first shaft 67 may comprise a shoulder that serves as a mechanical stop for ensuring a nominal clearance between the nut and the uppermost crimp arm, or a slip washer may be provided in a known manner. Regardless, the crimp arms 64, 66 pivot about the first shaft 67 on the base plate 62 of the crimp mechanism 60 between the opened position shown in FIG. 4A and the closed position shown in FIG. 4B and FIG. 4C. The crimp arms 64, 66 may be pivoted by any suitable means that provides sufficient mechanical advantage such that the crimp mechanism 60 can be disposed on a handheld installation tool, as will be described, for terminating an optical fiber on a fiber optic connector. For purposes of the present disclosure, the optical fiber described herein is a tight-buffered optical fiber 50 comprising an optical waveguide 52 for transmitting optical signals and a buffer 55 extending radially outwardly of the optical waveguide. The fiber optic connector described herein is a field-installable mechanical splice connector of the type available from Corning Cable Systems LLC of Hickory, N.C., such as the UniCam® family of connectors. However, a crimp mechanism according to the present invention may be used to form a mechanical crimp around any suitable optical fiber terminated on any suitable fiber optic connector. For example and without limitation, the optical fiber may be a loose-tube optical fiber or cable comprising one or more optical waveguides and the fiber optic connector may be an epoxy cure connector or a fusion splice connector.

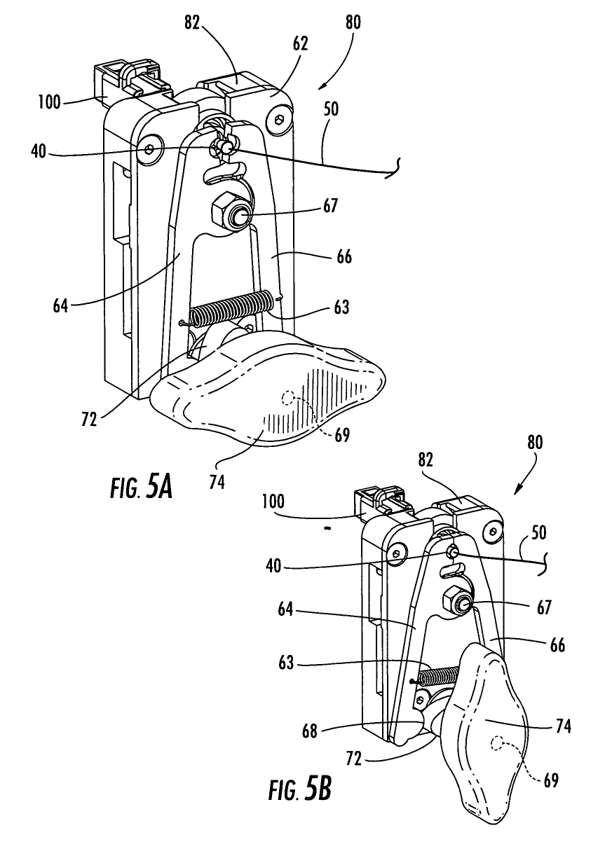

In the exemplary embodiments shown and described herein, the crimp mechanism 60 further comprises an actuator 70 for engaging and pivoting one or both crimp arms 64, 66 between the opened position and the closed position. As best shown in FIG. 4A and FIG. 4B, the actuator 70 comprises a drive eccentric 72 movably mounted on the base plate 62 and adapted to engage at least one of the crimp arms 64, 66. The eccentric 72 is movable between the first position wherein the crimp arms 64, 66 are spaced apart at the crimp area 65 and the second position wherein the crimp arms are not spaced apart at the crimp area. As shown, the eccentric 72 defines an elliptical outer contour that engages a corresponding cam surface 68 formed on an inner edge of at least one of the crimp arms 64, 66 to move one or both of the crimp arms between the opened position and the closed position. As such, the eccentric 72 is also commonly referred to as a “cam lobe.” In particular, the eccentric 72 is pivotally mounted to the base plate 62 and operable to rotate relative to at least one of the crimp arms 64, 66 on an internal second shaft 69 (indicated by broken lines in FIGS. 5A; 5B; 6A; and 6B). The second shaft (or pivot) 69 is preferably generally parallel to the first shaft 67, which in turn, is preferably generally perpendicular to the first plane defined by the base plate 62 and the second plane defined by the crimp arms 64, 66. The second shaft 69 is preferably, but not necessarily, disposed between the crimp arms 64, 66, and the first shaft 67, and the first shaft is disposed medially between the crimp area 65 and the second shaft 69. Rotation of the eccentric 72 on the second shaft 69 provides sufficient mechanical advantage to form the crimp despite the compact size of the crimp mechanism 60. The eccentric 72 may be rotated (or pivoted) on the second shaft 69 in any convenient manner, and may be adapted to rotate freely or to be indexed relative to the crimp arms 64, 66.

As shown, the eccentric 72 is secured on the second shaft 69 with one end of the shaft pivotally mounted on the base plate 62. The other end of the second shaft 69 is provided with an activation knob 74 shaped to be readily grasped by a technician or field installer and twisted (rotated) to form the crimp. The “twist-to-crimp” activation of the crimp mechanism 60 provides the force required to overcome the inherent hoop stress of the metal crimp tube 40 and thereby deform the generally circular cross section of the crimp tube into the desired geometry of the crimp without using the cantilevered crimp arms utilized by the known pliers-type crimp mechanisms shown in FIG. 1A and FIG. 2A. As a result, the crimp mechanism 60 can be constructed small enough to be easily disposed on a handheld installation tool for terminating an optical fiber on a fiber optical connector, such as a handheld installation tool for terminating a field optical fiber on a UniCam® field-installable mechanical splice connector available from Coming Cable Systems LLC of Hickory, N.C. The enlarged detail view of the crimp area 65 shown in FIG. 4C illustrates the shape of the opposing crimp arms 64, 66 necessary to produce the geometry of the “clover” crimp shown in FIG. 3. However, the crimp mechanism 60 should not be construed to be limited to form a crimp having a specific geometry. It should be noted that the crimp arms 64, 66 of the crimp mechanism 60 may be configured to produce a crimp having any desired geometry, including for example without limitation, the geometry of the “flat” crimp shown in FIG. 1B or the “diamond” crimp shown in FIG. 2B. The crimp mechanism 60 can also be adapted to receive interchangeable crimp arms 64, 66 configured to form crimps having different geometries, including without limitation, a “flat” crimp, a “diamond” crimp, a “clover” crimp, a “hex” crimp, or any other suitable crimp geometry.

Another embodiment of a crimp mechanism 80 according to the present invention suitable for forming a crimp around a deformable crimp tube 40 and an optical fiber 50 disposed within the crimp tube is shown in an opened position in FIG. SA, and is shown in a closed position in FIG. 5B. The structure and function of the crimp mechanism 80 is essentially identical to the structure and function of the same or similar components of the crimp mechanism 60 previously described with the exceptions noted herein. The base plate 62 of the crimp mechanism 80 is mounted onto a housing 82 by fasteners 81 through openings 61 (FIGS. 4A; and 4B) formed in the base plate. The housing 82 provides means for supporting a fiber optic connector 100 comprising a crimp tube 40 adjacent the rear of the connector and having an optical fiber 50 terminated on the connector. With the crimp mechanism 80 oriented as shown in FIG. SA, the minor axis of the eccentric 72 is arranged horizontally to position the crimp arms 64, 66 apart at the crimp area 65. In this configuration, the fiber optic connector 100 having the optical fiber 50 terminated thereon can be loaded into the housing 82 of the crimp mechanism 80. An elastic element 63, such as a conventional tension spring, may be positioned between the crimp arms 64, 66 for biasing the crimp arms together adjacent the eccentric 72 and apart at the crimp area 65. Once the fiber optic connector is mounted on the housing 82, the activation knob 74 is turned from the position indicated in FIG. 5A to the position indicated in FIG. 5B to rotate the eccentric 72. With the crimp mechanism 80 oriented as shown in FIG. 5B, the major axis of the eccentric 72 is arranged horizontally to close the crimp arms 64, 66 together at the crimp area 65. Preferably, the crimp arms 64, 66 close together as the eccentric 72 travels along the cam surface 68 provided on the inner edge of one or both of the crimp arms. As the crimp arms 64, 66 are closed together, a crimp is formed around the crimp tube 40 and the optical fiber 50 to strain-relieve, and thereby retain, the optical fiber on the fiber optic connector 100. The activation knob 74 is thereafter turned back to the position indicated in FIG. 5A to rotate the eccentric 72 again and return the crimp mechanism 80 to the opened position. In this configuration, the fiber optic connector 100 having the optical fiber 50 mechanically strain-relieved to the connector can be removed from the housing 82. It should be noted that the activation knob 74 may be turned in the clockwise direction or the counter-clockwise direction to rotate the eccentric 72 between the opened position and the closed position. Furthermore, the tension of the spring 63 and the geometry of the eccentric 72 and/or cam surface 68 may be designed to automatically return the crimp mechanism 80 to the opened position to remove the fiber optic connector 100.

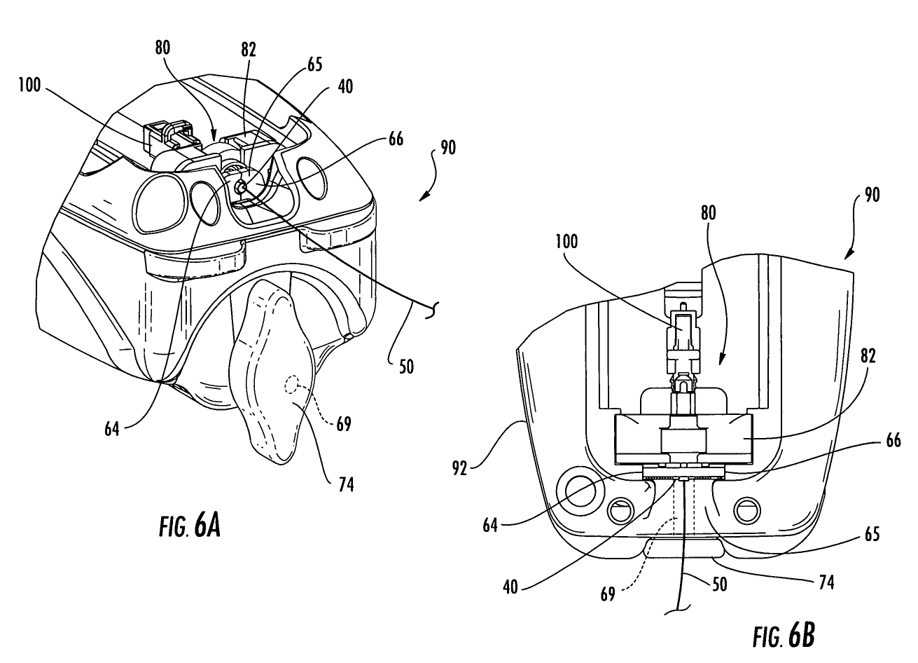

FIG. 6A and FIG. 6B show the crimp mechanism 80 disposed on a handheld installation tool 90 for terminating an optical fiber 50 to a fiber optic connector 100 according to the present invention. The installation tool 90 may be any device configured to be held and operated in one hand by a field installer or technician. By way of example and without limitation, the installation tool 90 may be a handheld installation tool for terminating a field optical fiber on a UniCam® field-installable mechanical splice connector available from Coming Cable Systems LLC of Hickory, N.C. As previously described, the crimp mechanism 80 is suitable for forming a crimp around a deformable crimp tube 40 adjacent the rear of the connector 100 and the optical fiber 50 disposed within the crimp tube. The structure and function of the crimp mechanism 80 is essentially as previously described with the exceptions noted herein. The housing 82 of the crimp mechanism 80 is positioned adjacent one end of the handheld installation tool 90 so that the activation knob 74 is readily accessible to a field installer or technician. The fiber optic connector 100 is mounted on the installation tool 90 and loaded into the housing 82 of the crimp mechanism 80 with the crimp mechanism in the opened position shown in FIG. 5A. The optical fiber 50 is then terminated to the connector 100 in a suitable manner, which forms no part of the present invention. If the termination is acceptable, for example the attenuation as a result of the terminating the optical fiber 50 to the connector 100 is less than a threshold amount as measured using a visual fault locator (VFL) or other continuity test, the field installer or technician next turns the activation knob 74 to rotate the eccentric (not shown) on the second shaft (or pivot) 69 from the opened position to the closed position. As the eccentric rotates, the crimp arms 64, 66 close together at the crimp area 65 to form a crimp around the crimp tube 40 and the optical fiber 50 in the manner previously described to retain the optical fiber on the connector. Once the crimp is formed, the activation knob 74 is turned again (or released against the tension force of the spring 63) to rotate the eccentric and move the crimp arms 64, 66 apart at the crimp area 65. Thereafter, the fiber optic connector 100 with the optical fiber 50 terminated and strain-relieved thereto is removed form the handheld installation tool 90. The compact “twist-to-crimp” design of the crimp mechanism 80 provides sufficient mechanical advantage to generate the crimp force necessary to overcome the inherent hoop stress of the crimp tube 40, while permitting the crimp mechanism to be disposed on the handheld installation tool 90.

The foregoing is a description of various embodiments of the invention that are given here by way of example only. Although a crimp and a crimp mechanism according to the present invention have been described with reference to preferred embodiments and examples thereof, other embodiments and examples may perform similar functions and/or achieve similar results. All such equivalent embodiments and examples are within the spirit and scope of the present invention and are intended to be covered by the appended claims.

That which is claimed is:

1. A crimp for retaining an optical fiber on a fiber optic connector, the crimp comprising:
a deformable crimp tube; and
an optical fiber disposed within the crimp tube, the optical fiber comprising an optical waveguide for transmitting optical signals and a buffer extending radially outwardly of the optical waveguide;
wherein the crimp tube is deformed by a crimp mechanism to impinge upon the buffer such that a radial cross section of the deformed crimp tube defines a plurality of alternating concave and convex outer surfaces.

2. A crimp according to claim 1, wherein the plurality of alternating concave and convex outer surfaces comprises at least a first pair of opposing concave outer surfaces and a second pair of opposing concave outer surfaces.

3. A crimp according to claim 2, wherein the first pair of concave outer surfaces and the second pair of concave outer surfaces are separated by convex outer surfaces.

4. A crimp according to claim 1, wherein the plurality of alternating concave and convex outer surfaces form a continuous clover shape.

5. A crimp according to claim 1, wherein the crimp tube is made of a malleable metal.

6. A crimp for retaining an optical fiber on a fiber optic connector, the crimp comprising:
an optical fiber comprising an optical waveguide for transmitting optical signals and a buffer extending radially outwardly of the optical waveguide; and
a deformable crimp tube disposed about the optical fiber, the crimp tube having a radial cross section that is generally circular in an un-deformed configuration and that comprises more than four points of inflection in a deformed configuration.

7. A crimp according to claim 6, wherein the points of inflection define a plurality of alternating concave and convex outer surfaces comprising at least a first pair of opposing concave outer surfaces and a second pair of opposing concave outer surfaces separated by convex outer surfaces.

8. A crimp according to claim 7, wherein the radial cross section of the crimp tube forms a continuous clover shape in the deformed configuration.

9. A crimp according to claim 6, wherein the crimp tube is made of a malleable metal.

10. A crimp mechanism for forming a crimp to retain an optical fiber on a fiber optic connector, the crimp mechanism comprising:
a base plate;
a pair of crimp arms movably mounted on the base plate, the crimp arms defining a crimp area for forming the crimp;
an eccentric movably mounted on the base plate and adapted to engage at least one of the crimp arms, the eccentric being movable between a first position wherein the crimp arms are spaced apart at the crimp area and a second position wherein the crimp arms are not spaced apart at the crimp area.

11. A crimp mechanism according to claim 9, wherein the crimp arms are pivotally mounted to the base plate about a first shaft and wherein the eccentric is pivotally mounted to the base plate about a second shaft.

12. A crimp mechanism according to claim 9, wherein the eccentric is disposed between the crimp arms and further comprising means for rotating the eccentric relative to the base plate and the crimp arms to form the crimp.

13. A crimp mechanism according to claim 9, further comprising an elastic element for biasing the crimp arms apart at the crimp area.

14. A crimp mechanism comprising:
a pair of crimp arms, at least one crimp arm being movable relative to the other crimp arm between an opened position for receiving a crimp element and a closed position for forming a crimp on the crimp element; and
an actuator adapted to engage the at least one crimp arm and operable to rotate relative to the at least one crimp arm between the opened position and the closed position.

15. A crimp mechanism according to claim 14, wherein the actuator comprises an eccentric and wherein the at least one crimp arm comprises a cam surface that is engaged by the eccentric to move the at least one crimp arm between the opened position and the closed position.

16. A crimp mechanism according to claim 14, wherein the crimp arms are pivotally mounted on a first shaft and the eccentric is pivotally mounted on a second shaft disposed between the crimp arms.

17. A crimp mechanism according to claim 16, wherein the crimp arms define a crimp area and wherein the first shaft is positioned medially between the crimp area and the second shaft.

18. A crimp mechanism according to claim 16, wherein the first shaft is generally perpendicular to a plane defined by the crimp arms and the second shaft is generally parallel to the first shaft.

19. A crimp mechanism for forming a crimp on a deformable crimp tube to retain an optical fiber on a fiber optic connector, the crimp mechanism comprising:
a base plate defining a first plane;
a pair of crimp arms disposed in a second plane generally parallel to the first plane, the crimp arms defining a crimp area and at least one crimp arm being movable relative to the other crimp arm about a first pivot secured to the base plate and generally perpendicular to the second plane;
an actuator movably mounted on a second pivot secured to the base plate and generally parallel to the first pivot, the actuator engaging the at least one crimp arm to move the at least one crimp arm about the first pivot between an opened position for receiving the crimp tube and the optical fiber and a closed position for forming the crimp on the crimp tube and the optical fiber.

20. A method of forming a crimp on a deformable crimp tube to retain an optical fiber on a fiber optic connector, the method comprising:
terminating the optical fiber on the fiber optic connector;
once the optical fiber is terminated on the connector, rotating an actuator between a first position and a second position to move at least one crimp arm of a pair of crimp arms of a crimp mechanism so that the crimp arms close together to form the crimp on the crimp tube; and
rotating the actuator between the second position and the first position so that the crimp arms move apart to release the crimp tube and the optical fiber from the crimp mechanism.
